(19) United States
(12) Patent Application Publication
(10) Pub. No.: US 2013/0046498 A1
(43) Pub. Date: Feb. 21, 2013

(54) MULTI-TESTING PROCEDURE MANAGEMENT METHOD AND SYSTEM

(71) Applicants: TAICHUN CHEN, TAIPEI CITY (TW); CHING-FENG HSIEH, TAIPEI CITY (TW)

(72) Inventors: TAICHUN CHEN, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/274,374

(22) Filed: Oct. 17, 2011

(30) Foreign Application Priority Data
Aug. 16, 2011 (TW) 100129235

(51) Int. Cl. G06F 19/00

(52) U.S. Cl. 702/83

(57) ABSTRACT

A multi-testing procedure management method tests on a testing platform a plurality of function units of a plurality of devices under testing (DUTs) by a test schedule management list enumerating a plurality of schedule items. The method includes determining, by comparing the schedule items on the test schedule management list, whether the schedule items are directly applicable to testing the function units; keeping the schedule items in case of affirmative determination; and deleting the schedule items in case of negative determination. The method further includes selecting existing built-in items from a test library or creating and adding new test items to the test schedule management list to eventually produce a revised version of the test schedule management list for testing the DUTs. A multi-testing procedure management system is further provided.

### CROSS-REFERENCE TO RELATED APPLICATION

This non-provisional application claims priority under 35 U.S.C. §119(a) on Patent Application No(s). 100129235 filed in Taiwan, R.O.C. on Aug. 16, 2011, the entire contents of which are hereby incorporated by reference.

### FIELD OF TECHNOLOGY

The present invention relates to testing procedure management methods and systems, and more particularly, to a multi-testing procedure management method and system for testing a plurality of devices under testing (DUTs) having a plurality of function units which are different or identical with a single testing computer in a testing stage and testing the DUTs by adjusting original schedule items quickly.

### BACKGROUND

As disclosed in the prior art, an assembly process of an electronic product is always followed by a testing process performed on the electronic product by a testing worker of a product inspection department with a view to ensuring that a product will be flawless when purchased by consumers.

The testing worker performs a test on the electronic product in accordance with a testing process flow and method. Adjustment of the test items of the test depends on the requirements of the electronic product. For example, the test items include tests which are conducted to evaluate the electrical state, hardware functions, software functions or input/output signals of the electronic product, including tests conducted on the electronic product in terms of a synchronous electrical signal, a video signal, a sound signal, an electrical status of an electrical port, a signal to noise ratio, or an eye diagram, for example. Regarding the electronic product described herein, components which input/output a signal or generate different electrical statuses are hereinafter collectively referred to as function units.

In general, each testing worker tests a single electronic product with a single testing instrument and determines, according to a test result, whether the electronic product is good or bad. However, the testing method entails determining the time taken to execute the testing process according to the quantity of the function units of the electronic product. Hence, testing a large number of electronic products is time-consuming and labor intensive.

In view of this, the prior art teaches testing a single electronic product by means of a computer control system and transmitting testing signals and tested signals between the electronic product and the computer control system by means of a data acquisition (DAQ) card disposed between two products. In this regard, the testing method based on the computer control system is controlled by a core program, and the core program is usually dedicated to a specific type of electronic products. As a result, it is difficult for the core program to be used in testing the other types of electronic products. Hence, to test another type of electronic products, it is necessary to rewrite a special program for testing the electronic products, and doing so is costly and inconvenient.

Accordingly, it is imperative to overcome the aforesaid drawbacks of the prior art, using the method and system provided by the present invention.

### SUMMARY

It is an objective of the present invention to provide a multi-testing procedure management method for testing a plurality of devices under testing (DUTs) having a plurality of function units by a test schedule management list enumerating a plurality of schedule items which are configurable quickly and easily with a view to testing any DUTs.

Another objective of the present invention is that the multi-testing procedure management method entails keeping the schedule items in the test schedule management list and removing the schedule items from the test schedule management list to test the DUTs having the function units.

Yet another objective of the present invention is that the multi-testing procedure management method entails revising one of the built-in items in the test schedule management list or creating a new item in the test schedule management list for testing the DUTs having the function units.

A further objective of the present invention is to provide a multi-testing procedure management system for performing on a testing platform a multi-testing procedure on a plurality of devices under testing (DUTs) having a plurality of identical or different function units by turns or in parallel.

In order to achieve the above and other objectives, the present invention provides a multi-testing procedure management method for testing on a testing platform a plurality of function units of a plurality of devices under testing (DUTs) by a test schedule management list enumerating a plurality of schedule items. The schedule items are selected from a test library having a plurality of built-in items. The multi-testing procedure management method comprises the steps of: comparing the schedule items in the test schedule management list based on the function units in the DUTs; keeping in the test schedule management list the schedule items intended for use in testing the function units and removing from the test schedule management list the schedule items not intended for use in testing the function units; selecting from the test library the built-in items and adding the selected built-in items to the test schedule management list intended for use in testing the function units; and testing the function units with the schedule items based on the test schedule management list thus adjusted.

In order to achieve the above and other objectives, the present invention provides a multi-testing procedure management system for testing on a testing platform a plurality of devices under testing (DUTs) having a plurality of function units. Upon completion of the testing, the function units generate and send a plurality of measured signals to the testing platform. The system comprises a measuring module, an interface unit, a data acquisition unit, and a comparing unit. The measuring module is disposed on the testing platform, equipped with a test schedule management list having a plurality of schedule items, and adapted to output a plurality of testing signals according to the schedule items, wherein the schedule items have target values, respectively. The interface unit is connected to the measuring module for enabling the measuring module to perform bidirectional signal transmission. The data acquisition (DAQ) unit has a plurality of ports and is connected to the interface unit, wherein the testing signals are sent to the DUTs, respectively, via the data acquisition unit, such that the measured signals fed back from the DUTs are forwarded to the measuring module via the interface unit. The comparing unit is connected to the measuring module for comparing the received measured signals with the target values and determining, according to a result of the determination, whether the function units are operating well.

Compared with the prior art, the present invention provides a multi-testing procedure management method and system for performing a multi-testing procedure on a plurality of devices under testing (DUTs) having identical or different function units (capable of producing a synchronous electrical signal, a video signal, a sound signal, an electrical status of an electrical port, a signal to noise ratio, or an eye diagram, for example) according to a dynamically adjustable test schedule management list.

The present invention enables a testing worker to adjust the schedule items of the test schedule management list easily on a test production line according to the requirements of identical or different function units of each of the DUTs to be tested.

Under a testing condition, the testing worker is able to adjust the existing schedule items of the test schedule management list directly, keep or remove the schedule items as needed, and select a plurality of built-in items from the test library, so as to form an adjusted test schedule management list for performing a test on another DUT having different function units.

Under another testing condition, the testing worker is able to test the function units directly with the existing built-in items in the test library. Hence, the testing worker can select the built-in items corresponding to the function units, respectively, add the selected built-in items to the test schedule management list, and test the DUTs. The method of the present invention overcomes a drawback of the prior art, that is, DUTs with different schedule item requirements cannot be tested without using a rewritten dedicated testing program.

Under yet another testing condition, if the built-in items are unfit for use in testing a DUT having a new function unit, the testing worker can take the initiative in creating a new item whereby the new function unit can be tested. Preferably, the new item is tested and verified to make sure that it is suitable for testing the function units. Furthermore, the new item is stored in the test library to increase the built-in items in the test library.

Furthermore, although the schedule items can be used to test a new function unit, an amended item can be created by adjusting related parameter values (such as test duration, the number of test loops to be executed, output voltage, or output current) of the built-in items when confronted with the schedule items having different testing requirements, such that the amended item is conducive to testing identical test items under different conditions.

The present invention proposes that the schedule items are subjected to schedule control and management in a manner that multi-testing procedure management (MTPMs) can be carried out to DUTs having identical or different function units to not only reduce the time taken by a testing worker (or a programmer) to conduct a test thereon but also test, in conjunction with a high-speed measurement interface and an expandable data acquisition device, high-speed DUTs having a plurality of function units.

### BRIEF DESCRIPTION

Objectives, features, and advantages of the present invention are hereunder illustrated with specific embodiments in conjunction with the accompanying drawings, in which:

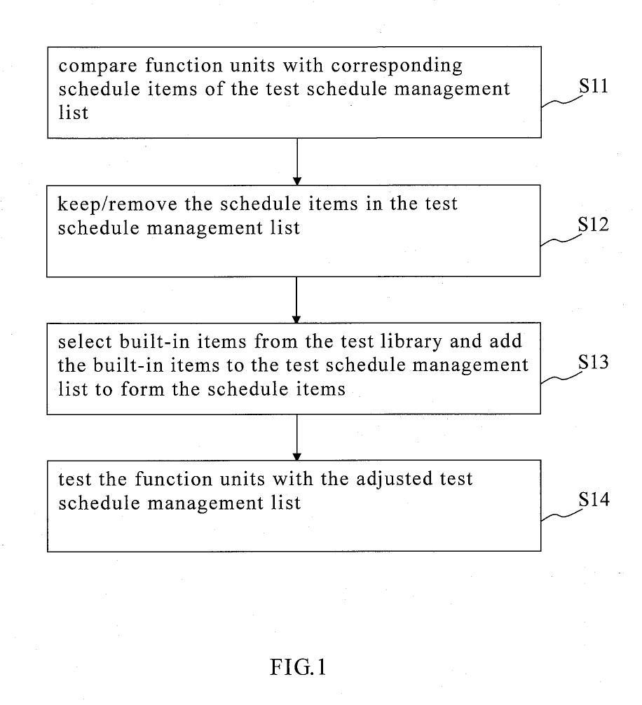

FIG. 1 is a flow chart of a multi-testing procedure management (MTPMs) method according to the first embodiment of the present invention;

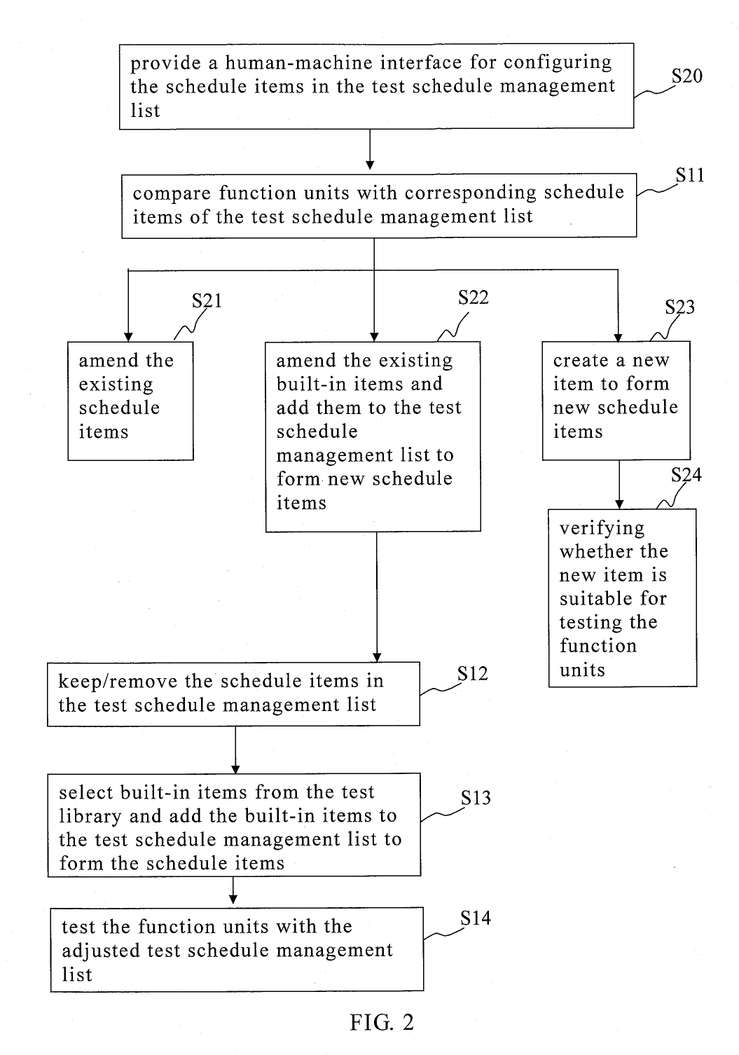

FIG. 2 is a flow chart of a multi-testing procedure management (MTPMs) method according to the second embodiment of the present invention;

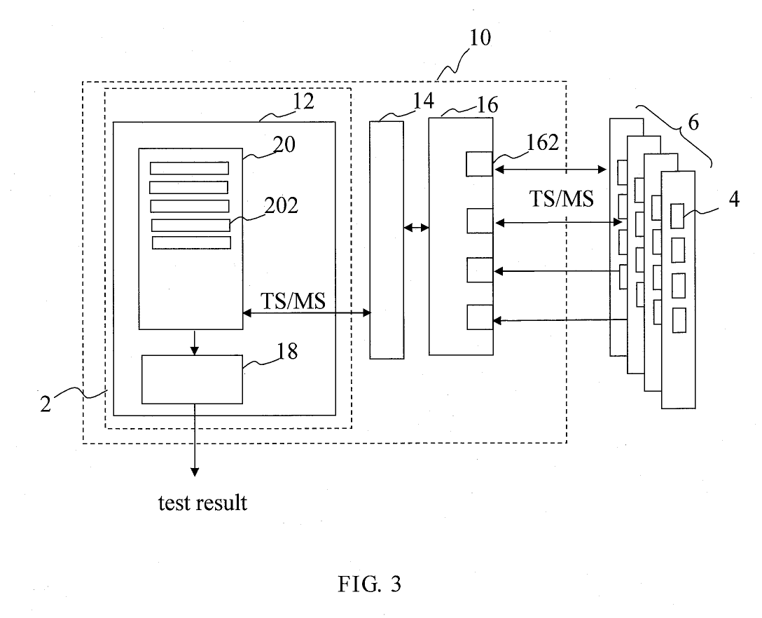

FIG. 3 is a block diagram of a multi-testing procedure management (MTPMs) system according to the first embodiment of the present invention; and

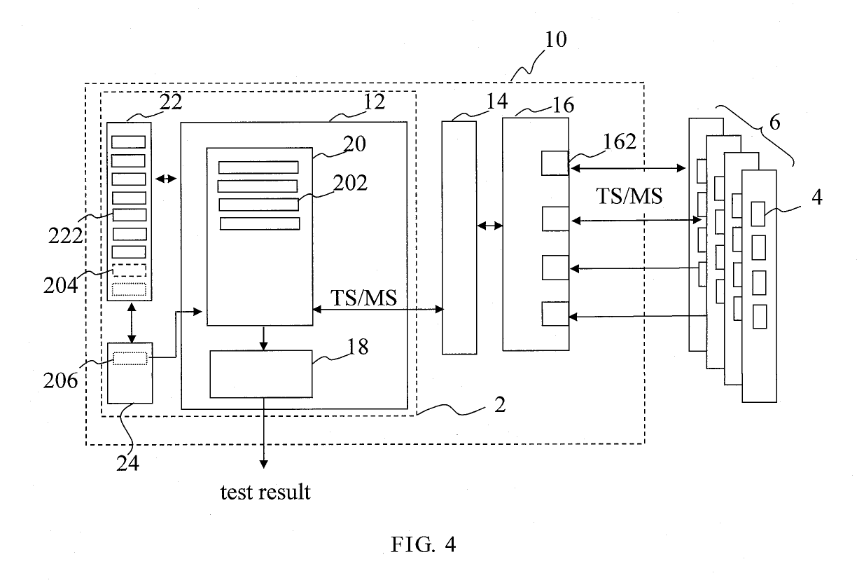

FIG. 4 is a block diagram of a multi-testing procedure management (MTPMs) system according to the second embodiment of the present invention.

### DETAILED DESCRIPTION

Referring to FIG. 1, there is shown a flow chart of a multi-testing procedure management (MTPMs) method according to the first embodiment of the present invention. As shown in FIG. 1, the multi-testing procedure management method is for use in testing on a testing platform a plurality of function units of a plurality of devices under testing (DUTs) by a test schedule management list enumerating a plurality of schedule items. In the first embodiment of the present invention, the DUTs are set-top boxes, network-based communication apparatuses, or electronic devices. In the first embodiment of the present invention, the function units relate to testing a signal or an electrical status, such as a synchronous electrical signal, a video signal, a sound signal, an electrical status of an electrical port, a signal to noise ratio, or an eye diagram. Furthermore, in the first embodiment of the present invention, the testing platform is a Laboratory Virtual Instrument Engineering Workbench (LabVIEW).

The function unit that comes in the form of a set-top box comprises a video output port, a sound output port, a high-definition multimedia interface (HDMI) port, a coaxial cable electrical port, and an Internet Protocol (IP) port. A testing worker tests the function units of the set-top box with the test schedule management list. For example, the testing worker sends an audiovisual signal (also known as a testing signal) to the coaxial cable electrical port, and then the audiovisual signal is encoded/converted by the set-top box and sent to the video output port, the HDMI port, the IP port, and the sound output port. Afterward, signal variations at the ports (also known as measured signals) are detected according to the method of the present invention, and then the signal variations are analyzed to determine whether they fall within an allowable target value range defined by the ports with a view to determining whether the ports are functioning well, before ending the test. It is also feasible that the target value range is defined by the schedule items.

Afterward, to test the network-based communication apparatus, the testing worker compares the schedule items of the test schedule management list previously used by the set-top box, so as to determine whether to keep the schedule items which are the same and keep related parameter values and target values of the schedule items. For example, it is feasible to keep the schedule items pertaining to the IP port in the test schedule. However, the test performed on the network-based communication apparatus is different from the test performed on the set-top box in that the former dispenses with any video-related test or sound-related test; hence, the former will work even if the schedule items pertaining to the video output port, the sound output port, the HDMI port, and the coaxial cable electrical port are removed from the test schedule management list. The test performed on the network-based communication apparatus further differs from the test performed on the set-top box in that the former entails testing up-stream/down-stream signals. With up-stream/down-stream signal-related schedule items being absent from the test schedule management list previously used by the set-top box, the testing worker has to select from the test library the built-in items pertaining to testing up-stream/down-stream signals and add the built-in items thus selected to the test schedule management list. In another embodiment, if the test library does not have the built-in items pertaining to testing up-stream/down-stream signals, the testing worker may create a new item independently and put the new item in the test schedule management list for testing the network-based communication apparatus.

The multi-testing procedure management method of the present invention is designed to be carried out on a testing platform and adapted to perform a test on a plurality of function units of a DUT with a test schedule management list having a plurality of schedule items, wherein the schedule items are selected from the test library having a plurality of built-in items. The process flow of the multi-testing procedure management method starts from step S11 which involves comparing the schedule items of the test schedule management list according to the function units of the DUTs and then identifying the schedule items corresponding to the function units, respectively. Hence, the purpose of step S11 is to determine whether the schedule items present in the test schedule management list are sufficient to perform a test on the function units.

Step S12 involves keeping in the test schedule management list the schedule items which are suitable for testing the function units and removing from the test schedule management list the schedule items which are not required for testing the function units according to the result of the comparison.

Step S13 involves selecting the built-in items from the test library and adding the built-in items thus selected to the test schedule management list for testing the function units. Before step S13, the built-in items suitable for testing the function units are present in the test library but absent from the test schedule management list.

In step S14, the function units are tested with the schedule items available on the adjusted test schedule management list that results from step S13.

The joint purpose of step S12 and step S13 is to dynamically deploy the schedule items suitable for testing the function units. Before their deployment, the deployable schedule items are either present on the test schedule management list or available in the form of the built-in items in the test library.

Referring to FIG. 2, there is shown a flow chart of a multi-testing procedure management (MTPMs) method according to the second embodiment of the present invention. As shown in FIG. 2, in addition to the aforesaid steps, the method of the present invention further comprises step S21 that follows step S11. In step S21, the schedule items present in the test schedule management list are amended to form amended items, and then the amended items are stored in the test library to become the built-in items therein. In other words, the predecessors of the amended item are the schedule items, and the destination of the amended item is the test library. The purpose of the amended item is to test the function units.

Under another testing condition, step S11 is further followed by step S22. In step S22, the built-in items in the test library are amended to form amended items, and then the amended items are added to the test schedule management list for testing the function units. Step S22 is different from step S21 in that, in step S22, the built-in items in the test library are directly amended to form amended items, and then the testing worker puts the amended items in the test schedule management list for testing the function units.

Under another testing condition, step S11 is further followed by step S23. In step S23, a new item is created in the test schedule management list, and then the new item is put in the test library to join the built-in items therein. The new item is new, because prior to its creation it does not exist in the test library.

Under another testing condition, the step S23 is followed by step S24. Step S24 involves verifying whether the new item is suitable for testing the function units. Hence, the new item is verified, for example, to determine whether the new item is suitable for testing a standard one of the function units such that the standard function unit generates a response signal based on the new item, and then the new item is verified to determine, according to the response signal, whether the new item is suitable for testing the function units.

Furthermore, in step S20 of the multi-testing procedure management method, the testing platform further comprises a human-machine interface for configuring the schedule items in the test schedule management list.

The above description is intended to be illustrative of steps S21, S22, S23, S24 which follow step S11. However, steps S21-S24 not only follow step S11 but also precedes or follows any one of the steps in the first embodiment. For example, steps S21-S24 can precede step S11. In other words, the multi-testing procedure management method of the present invention will work, provided that the creation of an amended item or the creation of a new item precedes a test performed on the function units.

Moreover, the schedule items are further provided with a termination procedure for stopping the test schedule management list from executing the schedule items, and the schedule items are each provided with an adjustable target value and an adjustable parameter value which are required for testing the DUTs having the same function units under different testing conditions. Hence, the function units which are identical can be tested by means of the schedule items which are identical. However, the function units are intended to attain the target values (such as a voltage level, a current level, or a signal intensity level) which fall within different numerical ranges, respectively, and attain the parameter values (such as a testing duration, the number of times of executing a test loop, or the amplitude of the output voltage or current) under different testing conditions. In addition, the schedule items and the built-in items are compiled to form a dynamic linking library.

Referring to FIG. 3, there is shown a block diagram of a multi-testing procedure management (MTPMs) system 10 according to the first embodiment of the present invention. As shown in FIG. 3, the multi-testing procedure management system 10 performs a test on a plurality of DUTs 6 having a plurality of function units 4 on a testing platform 2. After the test, the function units 4 generate and send a plurality of measured signals MS to the testing platform 2. The multi-testing procedure management system 10 comprises a measuring module 12, an interface unit 14, a data acquisition unit 16 and a comparing unit 18. The testing platform 2 is a Laboratory Virtual Instrument Engineering Workbench (LabVIEW).

The measuring module 12 is disposed on the testing platform 2. The measuring module 12 comprises a test schedule management list 20. The test schedule management list 20 has a plurality of schedule items 202 and generates and sends out a plurality of testing signals TS according to the schedule items 202, respectively. In another embodiment, the schedule items 202 have their respective target values for performing a related test on a plurality of devices under testing (DUTs) having identical function units under different testing conditions by adjusting the test schedule management list 20 dynamically.

The interface unit 14 is connected to the measuring module 12 for enabling the measuring module 12 to perform bidirectional signal transmission. The interface unit 14 receives the testing signals TS from the measuring module 12 and then sends the testing signals TS to the data acquisition unit 16. The interface unit 14 receives the measured signals MS from a plurality of devices under testing (DUTs) 6 via the data acquisition unit 16 and sends the measured signals MS to the measuring module 12. Hence, the interface unit 14 enables bidirectional signal transmission to take place between the measuring module 12 and the data acquisition unit 16. Also, in an embodiment, the interface unit 14 is a PCI eXtensions for Instrumentation (PXI) interface.

The data acquisition unit 16 comprises a plurality of ports 162. The data acquisition unit 16 is connected to the interface unit 14. The testing signals TS are sent to the DUTs 6, respectively, via the data acquisition unit 16 in a manner that each of the testing signals TS is provided to multiple said DUTs 6, thereby allowing the measuring module 12 to perform a multi-testing procedure on multiple said DUTs 6. In addition, after receiving the testing signals TS, the DUTs 6 feed the measured signals MS back to the data acquisition unit 16, and then the measured signals MS are forwarded to the measuring module 12 via the interface unit 14.

In an embodiment, the DUTs 6 are tested by turns or in parallel, depending on the layout of the schedule items 202 in the test schedule management list 20. Testing the DUTs 6 by turns means that the DUTs 6 are tested one by one. Testing the DUTs 6 in parallel means that the DUTs 6 are tested simultaneously.

The comparing unit 18 is connected to the measuring module 12. The comparing unit 18 compares the received measured signals MS with the target values to determine whether the function units 4 are functioning well. In other words, the status of each of the function units 4 is judged according to the difference between the target value and the measured signal MS.

Referring to FIG. 4, there is shown a block diagram of the multi-testing procedure management (MTPMs) system 10 according to the second embodiment of the present invention. As shown in FIG. 4, in addition to the measuring module 12, the interface unit 14, the data acquisition unit 16, and the comparing unit 18 in the first embodiment of the multi-testing procedure management (MTPMs) system 10, the multi-testing procedure management system 10 in the second embodiment of the present invention further comprises a test library 22.

The test library 22 comprises a plurality of built-in items 222. The built-in items 222 are stored in the test library 22 in advance. Appropriate ones of the built-in items 222 are selected to join the schedule items 202 in the test schedule management list 20. The test library 22 is connected to the measuring module 12.

Furthermore, the testing platform 2 further comprises a human-machine interface unit 24. The human-machine interface unit 24 is adapted to keep the schedule items 202 in the test schedule management list 20 and remove the schedule items 202 from the test schedule management list 20. To be specific, the human-machine interface unit 24 keeps in the test schedule management list 20 the schedule items 202 intended for use in testing the function units 4 but removes from the test schedule management list 20 the schedule items 202 not intended for use in testing the function units 4.

Under another testing condition, the human-machine interface unit 24 is adapted to select the built-in items 222 from the test library 22 and add the selected built-in items 222 to the test schedule management list 20. To be specific, the human-machine interface unit 24 selects from the test library 22 the built-in items 222 and adds the selected built-in items 222 to the test schedule management list 20 intended for use in testing the function units 4.

Under yet another testing condition, the human-machine interface unit 24 is adapted to amend the schedule items 202 in the test schedule management list 20 so as to create amended items 204 and store the amended items 204 in the test library 22.

Under a further testing condition, the human-machine interface unit 24 is adapted to create a new item 206 in the test schedule management list 20 and store the new item 206 in the test library 22. The new item 206 is defined as an item that is created by the human-machine interface unit 24 and does not exist in the test library 22 prior to the creation.

As disclosed in the present invention, a multi-testing procedure is performed on multiple said DUTs having identical or different function units according to a test schedule management list having a plurality of test items. The multi-testing procedure is rendered efficient not only by using built-in items stored in a test library, but also by selecting and arranging the built-in items, such that the built-in items thus selected and arranged join the schedule items in the test schedule management list; hence, the DUTs having different schedule item requirements can be quickly tested. Therefore, the system of the present invention overcomes a drawback of the prior art, that is, DUTs with different schedule item requirements cannot be tested without using a rewritten dedicated testing program.

Under another testing condition, if the built-in items are unfit for use in testing a DUT having a new function unit, the testing worker can take the initiative in creating a new item or amend the existing built-in items so as to increase the built-in items in order to test the new function unit.

The present invention enables a testing worker to dynamically adjust the schedule items of the test schedule management list and the sequence thereof easily on a test production line according to the requirements of identical or different function units of each of the DUTs to be tested, so as to not only reduce the time taken by a testing worker (or a programmer) to conduct a test thereon but also test, in conjunction with a high-speed measurement interface and an expandable data acquisition device, high-speed DUTs having a plurality of function units.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A multi-testing procedure management method for testing on a testing platform a plurality of function units of a plurality of devices under testing (DUTs) by a test schedule management list enumerating a plurality of schedule items, the schedule items being selected from a test library having a plurality of built-in items, the multi-testing procedure management method comprising the steps of:
comparing the schedule items in the test schedule management list based on the function units in the DUTs;
keeping in the test schedule management list the schedule items intended for use in testing the function units and removing from the test schedule management list the schedule items not intended for use in testing the function units;
selecting from the test library the built-in items and adding the selected built-in items to the test schedule management list intended for use in testing the function units; and
testing the function units with the schedule items based on the test schedule management list thus adjusted.

2. The multi-testing procedure management method of claim 1, further comprising the step of revising the built-in items in the test library to create amended items and adding the amended items to the test schedule management list for testing the function units.

3. The multi-testing procedure management method of claim 1, further comprising the step of creating a new item in the test schedule management list and storing the new item in the test library.

4. The multi-testing procedure management method of claim 1, wherein the schedule items have adjustable target values and parameter values for testing the same function units under different testing conditions.

5. The multi-testing procedure management method of claim 4, wherein the schedule items and the built-in items are compiled to form a dynamic linking library.

6. The multi-testing procedure management method of claim 1, wherein the testing platform further comprises a human-machine interface for configuring the schedule items in the test schedule management list.

7. The multi-testing procedure management method of claim 6, wherein the testing platform is a Laboratory Virtual Instrument Engineering Workbench.

8. A multi-testing procedure management system for testing on a testing platform a plurality of devices under testing (DUTs) having a plurality of function units, and the function units generating and sending a plurality of measured signals to the testing platform, the system comprising:
a measuring module disposed on the testing platform, equipped with a test schedule management list having a plurality of schedule items, and adapted to output a plurality of testing signals based on the schedule items, wherein the schedule items respectively have target values;
an interface unit connected to the measuring module for enabling the measuring module to perform bidirectional signal transmission;
a data acquisition unit having a plurality of ports and connected to the interface unit, wherein the testing signals are respectively sent to the DUTs via the data acquisition unit and the measured signals are fed back from the DUTs to the measuring module via the interface unit; and
a comparing unit connected to the measuring module for comparing the received measured signals with the target values and confirming the function units operating well based on a result of the comparison.

9. The multi-testing procedure management system of claim 8, further comprising a test library having a plurality of built-in items and connected to the measuring module, the built-in items being selected to be the schedule items of the test schedule management list.

10. The multi-testing procedure management system of claim 9, wherein the testing platform further comprises a human-machine interface unit for use in keeping the schedule items in the test schedule management list and removing the schedule items from the test schedule management list.

11. The multi-testing procedure management system of claim 8, wherein the testing platform is a Laboratory Virtual Instrument Engineering Workbench.

12. The multi-testing procedure management system of claim 8, wherein the interface unit is a PCI eXtensions for Instrumentation (PXI) interface.
